(19) United States
(12) Patent Application Publication
(10) Pub. No.: US 2011/0260903 A1
(43) Pub. Date: Oct. 27, 2011

(54) Universal remote control device in smart phone

(75) Inventor: SUK KUEN WONG, Hong Kong (HK)

(73) Assignee: ETERNAL ELECTRONICS LIMITED, HONG KONG (HK)

(21) Appl. No.: 12/767,825

(22) Filed: Apr. 27, 2010

(51) Int. Cl. G08C 19/12

(52) U.S. Cl. 341/176

(57) ABSTRACT

The present utility provides a universal remote control device in smart phone, where it consists of two components: a hardware device which can be connected to a smart phone through the hands-free/earpiece connector; and a piece of software application running on the smart phone. The hardware device consists of a microcontroller unit (MCU), an IR transmitter, an IR receiver and a power regeneration circuit. This device adds the IR front-end components to a smart phone, thus enabling it to have capability to receive and transmit IR signals compatible with those in the electrical appliances and their corresponding remote controls. The software application running on the smart phone is responsible for generating an audio signal to power the hardware device and displaying a graphical representation of the remote control, usually consisting of buttons, knots, dials, a simulated LCD, etc. The present invention provides a universal remote control device in smart phone as an enhancement. It is a low cost device which can transmit or receive IR signal.

### FIELD OF TECHNOLOGY

The present utility model provides a remote control device with a software program which enables a smart phone to become a universal remote control.

### BACKGROUND OF THE TECHNOLOGY

At present, most families have many electrical appliances such as TV, DVD machine, Hi-Fi and Set top boxes. Each electrical appliance usually comes with a special Infra-red (IR) remote control. It is cumbersome to have so many remote controls at home. Hence, there is a market for a universal remote control which can control all electrical appliances. However, a conventional universal remote control is quite expensive. Moreover, the set of command codes for each electrical appliance varies and the operator must first use the universal remote control to learn all the commands. To set up a universal remote properly takes a lot of time and is non-trivial. Problems such as mistakenly programming a button to do an unintended function, forgetting to program a function and failure to program a complicated sequence of functions are very common. Another problem with a traditional universal remote control is that the arrangement of the buttons will differ from that of the remote controls to be replaced. The operator has to learn and memorize this new arrangement and this often results in inconvenience and confusion.

### SUMMARY OF THE UTILITY MODEL

In order to solve the aforesaid problem, the present invention proposes a device as an enhancement accessory to a smart phone or similar computing units including and not limited to personal digital assistant (PDA), handheld game console and netbook.

The present invention consists of two components: a hardware device which can be connected to a smart phone through the hands-free/earpiece connector; and a piece of software application running on the smart phone.

The hardware device consists of a microcontroller unit (MCU), an IR transmitter, an IR receiver and a power regeneration circuit. This device adds the IR front-end components to a smart phone, thus enabling it to have capability to receive and transmit IR signals compatible with those in the electrical appliances and their corresponding remote controls. The power regeneration circuit in this device is used to extract power from the electrical signal in the audio output generated by the smart phone via the hands-free/earpiece connector.

The software application running on the smart phone is responsible for displaying a graphical representation of the remote control, usually consisting of buttons, knots, dials, a simulated LCD, etc.

For example, when this invention is used to control a CD player which has a remote control with 5 buttons, a graphical representation such as a picture or a rendered image of the 5 buttons will be displayed on the smart phone to mimic that remote control. Likewise, when this invention is used to control a TV with a 20-button remote control, the image of that remote control will be displayed. The concept is that a “skin” is used to replicate the actual remote control as a graphical representation that can be displayed on the smart phone. This flexibility and user-friendliness differentiate our invention with a conventional universal remote control.

The software is responsible for generating an audio signal to power the hardware device.

When the invention is used to replace a remote control of an electrical appliance, it must first put to “Learn” mode to register that appliance. The remote control of that appliance is put to point towards the device so that the IR receiver in the device can capture the IR signal transmitted by the remote control. A button on the remote control is pressed to send the signal and the device captures the IR signal. The data is decoded and the model information is extracted. Based on the model information, the software application can retrieve the “skin” of that remote control as well as the full set of commands from a database which can be stored in a computer or from a remote web server. The operator will optionally by prompt to confirm if the correct model has been selected. Alternatively, the operator can manually choose either the model or the “skin”. Once the registration is complete, that electrical appliance can be remotely controlled by the software application. In normal usage, there will be more than one registered appliances, the user can switch between different appliances through the User Interface (UI) of the software application.

To control a registered appliance, the user first selects that appliance. The corresponding skin will be displayed. If the smart phone has a touch screen, the user can press on the screen directly at the button. Otherwise, the user can navigate through the buttons to the desired button. Once the button is activated, the device sends the correct IR signal to the appliance so that the appliance can perform the corresponding function.

In addition, add-on features can be added to the software application to enhance the user experience, for example, informative labels beside the buttons, tool tips at the buttons, a summary of the user manual, audio feedback, custom-skin, etc.

When a command has to be sent, the command code is modulated into a square wave consisting of a sequence of Return to Zero (RZ) code and is transmitted to the left channel of the hands-free/earpiece output of the smart phone. At the same time, an inverted square wave of the same sequence is transmitted to the right channel. The signal is converted at the device to form the signal used to drive the IR transmitter.

A universal remote control device in smart phone according to the present invention connects with the processor, the LCD screen and the earpiece of the smart phone. It duplicates the outlook of the remote control on the LCD screen of the smart phone and therefore, user needs not to learn how to use the functions of the remote control device. Further, the cost of this universal remote control is comparatively low.

A universal remote control device in smart phone as described is comprises an IR transmitter, an IR receiver, a micro-controller unit (MCU) and a power regeneration circuit, wherein the micro-controller unit (MCU) connects with the headphone output of the smart phone, the power regeneration circuit and the IR transmitter, wherein the power regeneration circuit connects with the headphone output of the smart phone, the micro controller unit (MCU), the IR transmitter and the IR receiver, wherein the IR receiver connects with the power regeneration circuit and the microphone input of the smart phone. The device is connected to the smart phone via the hands-free/earpiece connector.

A universal remote control device in smart phone as described, of which the user puts any remote control towards the device and presses any of the buttons. The device will then receive the command code sent from the remote control and extract the model information of the remote control from the command code. From the model information, the device can extract all the control command from the database of the remote control and duplicate the outlook of the remote control on the LCD screen of the smart phone.

A universal remote control device in smart phone as described, of which the user presses a button of the remote control on the screen. The program of the device will extract the control code corresponding to the button. The program of the device will then convert the command code into Return to Zero (RZ) code. The program will then modulates this RZ code on a square wave and sends the wave to the left-channel of the hands-free/earpiece output of the smart phone. At the same time, an invert square wave of the same sequence is transmitted to the right channel. The signal is converted at the device to form the signal used to drive the IR transmitter.

A universal remote control device in smart phone as described, of which the circuit consists of diode-capacitor voltage multiplier or transformer to convert the sound wave into electric energy to power the device.

A universal remote control device in smart phone as described, of which it is preferable to have the sound wave to be a square wave, but the invention also works on other waveform such as sine wave.

The present invention is characterized in that it comprises an IR transmitter, an IR receiver, a micro-controller unit (MCU) and a power regeneration circuit, wherein the micro-controller unit (MCU) connects with the earpiece of the smart phone, the power regeneration circuit and the IR transmitter, wherein the power regeneration circuit connects with the earpiece of the smart phone, the micro controller unit (MCU), the IR transmitter and the IR receiver, wherein the IR receiver connects with the power regeneration circuit and the microphone input of the smart phone. The device is connected to the smart phone via earpiece. User puts any remote control towards the device and presses any of the buttons. The device will then receive the command code sent from the remote control and extract the model information of the remote control from the command code. From the model information, the device can extract all the control command from the database of the remote control and duplicate the outlook of the remote control on the LCD screen of the smart phone. User presses a button of the remote control on the screen. The program of the device will extract the control code corresponding to the button. The program of the device will then convert the command code into Return to Zero (RZ) code. The program will then modulates this RZ code on a square wave and sends the wave to the left-channel of the hands-free/earpiece output of the smart phone. At the same time, an invert square wave of the same sequence is transmitted to the right channel. The signal is converted at the device to form the signal used to drive the IR transmitter.

The present invention provides a universal remote control device in smart phone as an enhancement. It is a low cost device which can transmit or receive IR signal. The device is connected to a smart phone via earpiece. A program running in the smart phone output sound wave to provide power and IR command to the device to control an electric appliance. User needs not to learn how to use the device.

### EXPLANATION FOR ATTACHED DRAWING

FIG. 1 is the workflow of the device after receiving a command from a remote control

FIG. 2 is the workflow of the device after user pressed the button of the remote control on the screen

FIG. 3 is the structural drawing of the device

FIG. 4 is the first method the circuit converts sound wave into electricity

FIG. 5 is the second method the circuit converts sound wave into electricity

FIG. 6 is the third method the circuit converts sound wave into electricity

### PARTICULAR IMPLEMENTATION METHOD

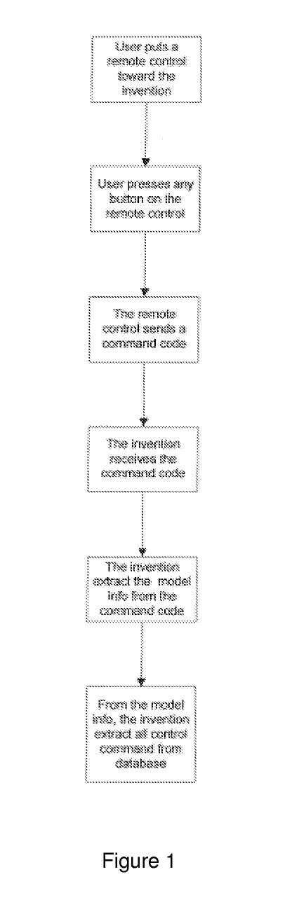

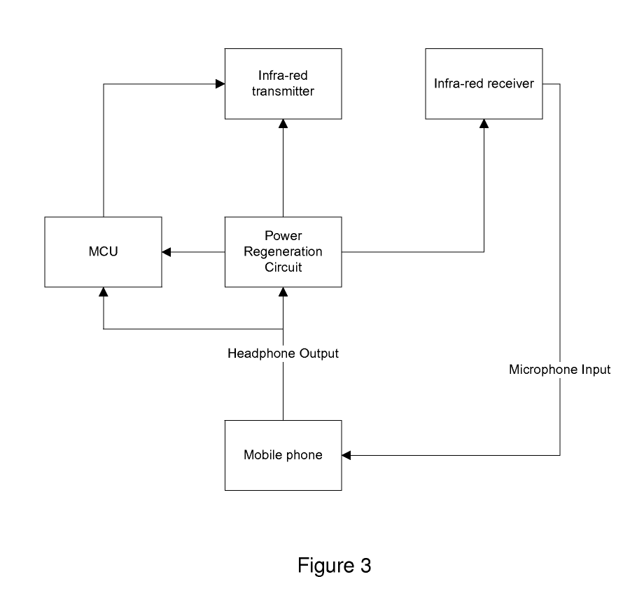

As described in FIG. 1-3, a universal remote control device in smart phone as described is comprises an IR transmitter, an IR receiver, a micro controller unit (MCU) and a power regeneration circuit, wherein the micro-controller unit (MCU) connects with the earpiece of the smart phone, the power regeneration circuit and the IR transmitter, wherein the power regeneration circuit connects with the earpiece of the smart phone, the micro-controller unit (MCU), the IR transmitter and the IR receiver, wherein the IR receiver connects with the power regeneration circuit and the microphone input of the smart phone. The device is connected to the smart phone via earpiece.

In FIG. 1, user puts any remote control towards the device and presses any of the buttons. The device will then receive the command code sent from the remote control and extract the model information of the remote control from the command code. From the model information, the device can extract all the control command from the database of the remote control and duplicate the outlook of the remote control on the LCD screen of the smart phone.

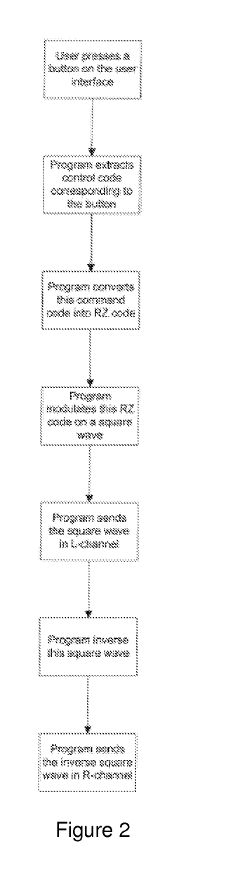

In FIG. 2, user presses a button of the remote control on the screen. The program of the device will extract the control code corresponding to the button. The program of the device will then convert the command code into Return to Zero (RZ) code. The program will then modulates this RZ code on a square wave and sends the wave to the left-channel of the hands-free/earpiece output of the smart phone. At the same time, an invert square wave of the same sequence is transmitted to the right channel. The signal is converted at the device to form the signal used to drive the IR transmitter.

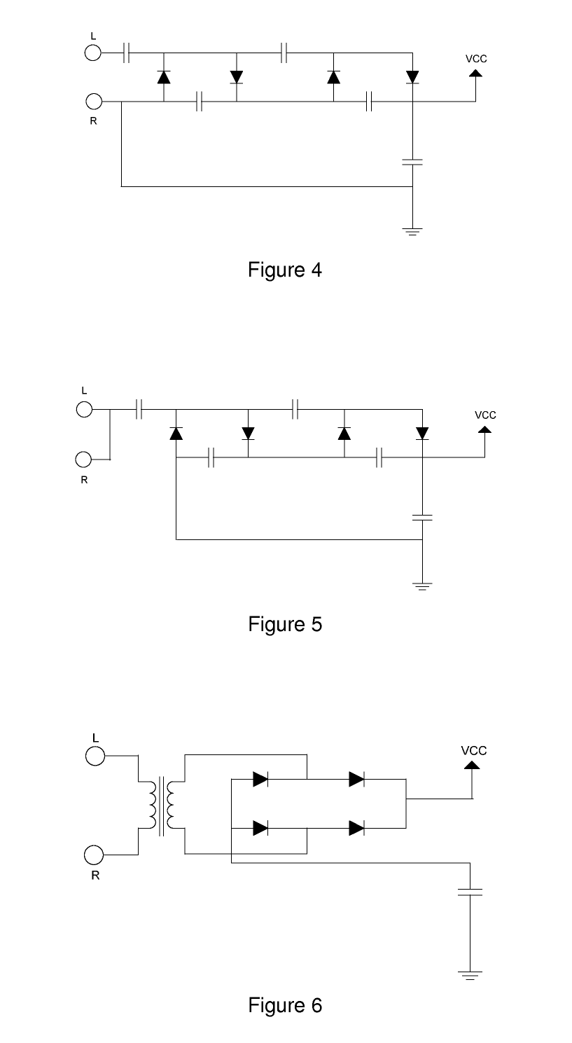

In FIG. 4-6, the circuit consists of diode-capacitor voltage multiplier or transformer to convert the sound wave into electric energy to power the device.

The present utility model operates with a smart phone which installed with appropriate program that the smart phone can become a universal remote control.

The present utility model prefers to have wave to be a square wave, but the invention also works on other waveform such as sine wave.

As described as above, the present invention is characterized in that it comprises an IR transmitter, an IR receiver, a micro-controller unit (MCU) and a power regeneration circuit, wherein the micro-controller unit (MCU) connects with the earpiece of the smart phone, the power regeneration circuit and the IR transmitter, wherein the power regeneration circuit connects with the earpiece of the smart phone, the micro controller unit (MCU), the IR transmitter and the IR receiver, wherein the IR receiver connects with the power regeneration circuit and the microphone input of the smart phone. The device is connected to the smart phone via earpiece. User puts any remote control towards the device and presses any of the buttons. The device will then receive the command code sent from the remote control and extract the model information of the remote control from the command code. From the model information, the device can extract all the control command from the database of the remote control and duplicate the outlook of the remote control on the LCD screen of the smart phone. User presses a button of the remote control on the screen. The program of the device will extract the control code corresponding to the button. The program of the device will then convert the command code into Return to Zero (RZ) code. The program will then modulates this RZ code on a square wave and sends the wave to the left-channel of the hands-free/earpiece output of the smart phone. At the same time, an invert square wave of the same sequence is transmitted to the right channel. The signal is converted at the device to form the signal used to drive the IR transmitter.

The universal remote control device in smart phone provided by the embodiment of the present invention is described in detail hereinbefore. As for the technical personnel generally skilled in the art, the embodiment and application scope may be changed to some extent according to the concept of the embodiment of the present invention. Therefore, the content of the specification does not set a limit on the present invention.

The invention claimed is:

1-6. (canceled)

7. A universal remote control device in smart phone comprises an Infrared(IR) transmitter device, an Infrared(IR) receiver, a software application running on the smart phone and a remote database server; wherein a graphic representation that closely resemble the actual remote is displayed on the smart phone for user remote control operation.

8. A universal remote control device in smart phone of claim 1, characterized in that the system enables a smart phone to become a universal remote control.

9. A universal remote control system in smart phone of claim 1, characterized in that the user needs not to program and learn the functions of the remote control as the downloaded graphical representation of the remote control shown in the display of the smart phone which has a close resemblance of the actual remote and contains the corresponding IR codes of the actual remote control.

10. A universal remote control system in smart phone of claim 1, characterized in that the IR transmitter device comprises of an IR transmitter component and the IR receiver device comprises of an IR receiver component, and the power circuitry is connected to the smart phone via the earpiece.

11. A universal remote control system in smart phone of claim 4, characterized in that the IR code data from the IR transmitter device is sent through the left or right or both audio channels via the earpiece of the smart phone; wherein the IR code data can be raw data signal, coded signal or modulated signal.

12. A universal remote control system in smart phone of claim 4, characterized in that the IR code data received by the IR receiver device is through the microphone input of the smart phone; wherein the IR code data is output from the IR receiver component

13. A universal remote control system in smart phone of claim 4, characterized in that the power can be extracted from the electrical audio signal from the earpiece directly or through a power circuitry such as a voltage multiplier or transformer; alternatively, a battery or charging capacitor can be used to provide the necessary power.

14. A universal remote control system in smart phone of claim 4, characterized in that the IR transmitter and the receiver devices optionally contain a microcontroller unit (MCU) for doing the encoding and decoding of the IR signal and other control functions.

15. A universal remote control system in smart phone of claim 4, characterized in that the control signal code data are sent through the left or right or both audio channels via the ear piece of the smart phone; wherein the control data can be raw data signal or modulated signal.

16. A universal remote control system in smart phone of claim 1, characterized in that a software application is running on the smart phone for displaying the graphical representation of the remote control on the smart phone and storing a collection of remote control models as selected by the user.

17. A universal remote control system in smart phone of claim 1, characterized in that a plurality of remote control models are available for download from a remote database server.

18. A universal remote control system in smart phone of claim 11, characterized in that the graphical representation and all the IR control codes corresponding to the specific remote control based on the brand and model of the remote control can be retrieved from the said remote database server of claim 11.

19. A universal remote control system in smart phone of claim 11, characterized in that the user can manage the collection of remote control models that has been downloaded; wherein the user can add or remove from the said collection of downloaded remote control models.

20. A universal remote control system in smart phone of claim 11, characterized in that users are alerted when new remote control models or updates of existing remote control models are available for download.

21. A universal remote control system in smart phone of claim 1, characterized in that the smart phone can also be a PDA, tablet, netbook, electronic reader, digital multimedia player, portable computer, set-top box or an interne appliance.
